(19) United States
(12) Patent Application Publication
(10) Pub. No.: US 2005/0245319 A1
(43) Pub. Date: Nov. 3, 2005

(54) Boot for constant velocity joint

(76) Inventor: Hiroyuki Sato, Shizuoka (JP)

Correspondence Address: JACOBSON HOLMAN PLLC, 400 SEVENTH STREET N.W., SUITE 600, WASHINGTON, DC, 20004, US

(21) Appl. No.: 10/515,310

(22) PCT Filed: Feb. 24, 2004
(86) PCT No.: PCT/JP04/02117

§ 371 Date: Nov. 22, 2004

(30) Foreign Application Priority Data
Feb. 25, 2003 (JP) 2003-046956

(51) Int. Cl. F16C 1/26

(52) U.S. Cl. 464/173

(57) ABSTRACT

To secure sealing capability of a boot for a constant velocity joint, the boot has a large diameter-side mounting portion mounted on an outer ring of a constant velocity joint, the outer ring has circumferential recess portions on its outer peripheral surface, a tubular portion fitted on the outer peripheral side of the outer ring, circumferential convex portions provided on the inner peripheral surface of the tubular portion in correspondence to the recess portions, and an axial end surface portion opposite to a leading end surface of the outer ring are integrally formed in the large diameter-side mounting portion, end surface seal portions are provided at positions opposite to leading end surfaces of recess portions of the axial end surface portion, and the end surface seal portions are in close contact with the leading end surfaces of the recess portions.

### TECHNICAL FIELD

The present invention relates to a boot for a constant velocity joint which is used in a state of being attached to a constant velocity joint (a universal joint), and more particularly to a boot for a constant velocity joint which improves a sealing performance between the boot and an outer ring of the constant velocity joint.

### BACKGROUND ART

For example, as shown in FIG. 9, a curved recess portion 53 is formed at three circumferential positions of an outer peripheral surface of an outer ring 52 which is a constituting part of a tri-port type constant velocity joint 51, and on the other hand, an inner peripheral surface shape (a seal surface) having a shape corresponding to the outer peripheral surface shape of the outer ring 52 is formed in a boot 55 used in a state of being attached to the tri-port type constant velocity joint 51 as shown in FIG. 9. Further, the structure is made such that the boot 55 is fastened to the joint 51 by fastening strongly by means of a metal band (not shown) (refer to Japanese Unexamined Patent Publication No. 2002-122237). However, if a phase shift is generated between the boot 55 and the joint 51 due to some kind or another reason, a gap is generated in a seal surface between both the elements, so that there is a risk that a lubricating grease leaks from the gap.

For example, a low temperature state at an air temperature of about −40° C. generates an ambient atmosphere condition near a glass transition point of an elastic plastic, a rubber or the like which is used as a raw material of the boot. When starting an engine of a vehicle so as to rotate a joint (a tire), the joint is always actuated around its axis in a bending manner. Accordingly, the boot is deformed asymmetrically. In particular, since a rigidity of the boot itself becomes high in the low temperature state mentioned above, the boot can not follow a motion of the joint, and a shift is generated in a mounting phase between the boot and the joint.

Further, there is recently a tendency that three roller bearings installed within the joint are large in scale in accordance with a high torque of the engine, and three recess portions provided in the outer ring tend to be shallow and small in an outer peripheral direction in accordance with the tendency mentioned above. Accordingly, this matter is one of the reasons why the phase shift is generated between the boot and the joint.

The present invention is made by taking the point mentioned above into consideration, and an object of the present invention is to provide a boot for a constant velocity joint which can secure a sealing performance between a boot and a joint even if a phase shift is generated between them, whereby it is possible to effectively prevent a grease from leaking from a gap between both the elements.

### DISCLOSURE OF THE INVENTION

In order to achieve the object mentioned above, in accordance with a first aspect of the present invention, there is provided a boot for a constant velocity joint having a large-diameter side mounting portion mounted to an outer ring of a constant velocity joint provided with a plurality of circumferential recess portions on an outer peripheral surface, in which a tubular portion fitly attached to an outer peripheral side of the outer ring, a plurality of circumferential convex portions provided on an inner peripheral surface of the tubular portion in correspondence to the recess portion, and an axial end surface portion opposing to a leading end surface of the outer ring are integrally formed in the large-diameter side mounting portion, wherein an end surface seal portion is provided at a position opposing to a leading end surface of the recess portion in the axial end surface portion of the large-diameter side mounting portion, and the end surface seal portion is brought into close contact with the leading end surface of the recess portion, thereby generating a seal surface pressure to achieve a seal effect.

Further, in accordance with a second aspect of the present invention, there is provided a boot for a constant velocity joint having a large-diameter side mounting portion mounted to an outer ring of a constant velocity joint provided with a plurality of circumferential recess portions on an outer peripheral surface, in which a tubular portion fitly attached to an outer peripheral side of the outer ring, a plurality of circumferential convex portions provided on an inner peripheral surface of the tubular portion in correspondence to the recess portion, and an axial end surface portion opposing to a leading end surface of the outer ring are integrally formed in the large-diameter side mounting portion, wherein an end surface seal portion is provided all around an entire periphery of the axial end surface portion of the large-diameter side mounting portion, and the end surface seal portion is brought into close contact with the leading end surface of the outer ring, thereby generating a seal surface pressure to achieve a seal effect.

In the boot in accordance with the first aspect of the present invention provided with the structure mentioned above, the end surface seal portion is provided in the axial end surface portion of the large-diameter side mounting portion of the boot, and the end surface seal portion is brought into close contact with the leading end surface of the recess portion in the outer ring of the joint, thereby generating the seal surface pressure so as to achieve the seal effect with respect to the leading end surface of the recess portion. Accordingly, in comparison with the conventional boot in which the seal portion is constituted only by the inner peripheral surface of the tubular portion of the large-diameter side mounting portion, the end surface seal portion can be added newly in accordance with the present invention. Accordingly, it is possible to improve the sealing performance between the boot and the joint by the end surface seal portion. In this case, in the first aspect of the present invention, the end surface seal portion is provided only at the position opposing to the leading end surface of the recess portion in the axial end surface portion of the large-diameter side mounting portion of the boot. Therefore, in the case that the recess portion is provided at three positions on the circumference of the joint outer ring such as the tri-port type constant velocity joint mentioned above, the end surface seal portion is provided at three positions on the circumference in correspondence thereto.

Further, in the boot in accordance with the second aspect of the present invention provided with the structure mentioned above, the end surface seal portion is provided in the axial end surface portion of the large-diameter side mounting portion of the boot, and the end surface seal portion is brought into close contact with the leading end surface of the recess portion in the outer ring of the joint, thereby generating the seal surface pressure so as to achieve the seal effect with respect to the leading end surface of the outer ring. Accordingly, in comparison with the conventional boot in which the seal portion is constituted only by the inner peripheral surface of the tubular portion of the large-diameter side mounting portion, the end surface seal portion can be added newly in accordance with the present invention. Accordingly, it is possible to improve the sealing performance between the boot and the joint by the end surface seal portion. In this case, in the second aspect of the present invention, the end surface seal portion is provided all around the entire periphery of the axial end surface portion of the large-diameter side mounting portion of the boot.

### BRIEF DESCRIPTION OF THE DRAWINGS

FIG. 1 is a front view of an outer ring of a joint to which a boot in accordance with a first embodiment of the present invention is attached;

FIG. 2 is a front view of the boot;

FIG. 3 is a cross sectional view along a line A-A in FIG. 2;

FIG. 4 is an enlarged view of a portion B in FIG. 3;

FIG. 5 is a cross sectional view showing another example of an end surface seal portion;

FIG. 6 is a front view of an outer ring of a joint to which a boot in accordance with a second embodiment of the present invention is attached;

FIG. 7 is a front view of the boot;

FIG. 8 is a cross sectional view along a line C-C in FIG. 7; and

FIG. 9 is a schematic view of a joint and a boot in accordance with a conventional art.

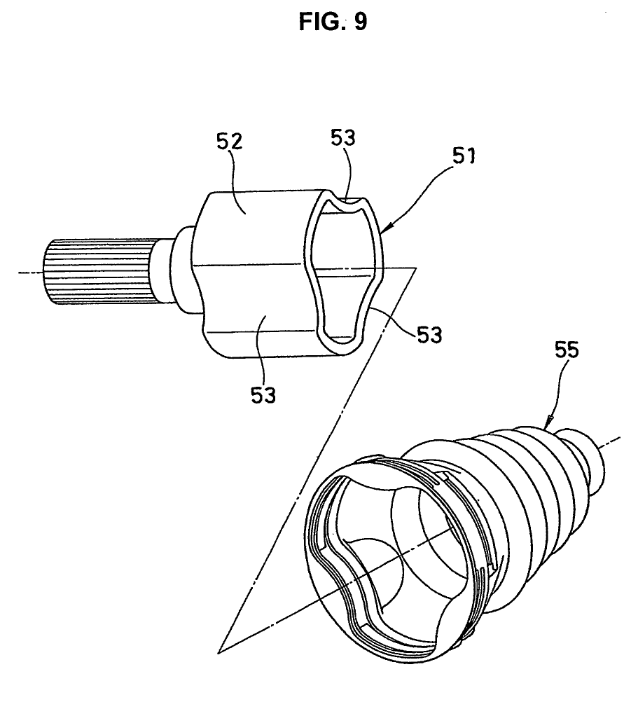

### BEST MODE FOR CARRYING OUT THE INVENTION

### First Embodiment (Relevance to Claim 1)

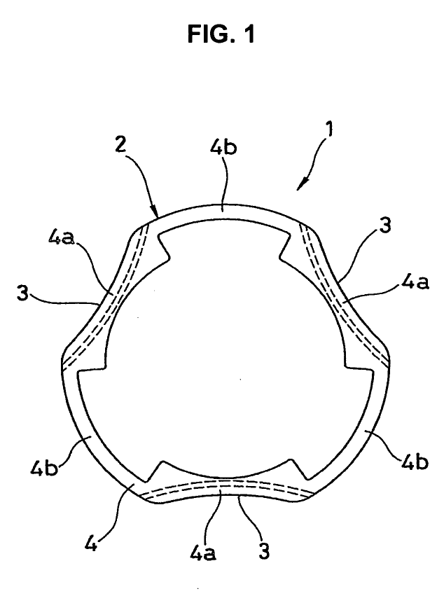

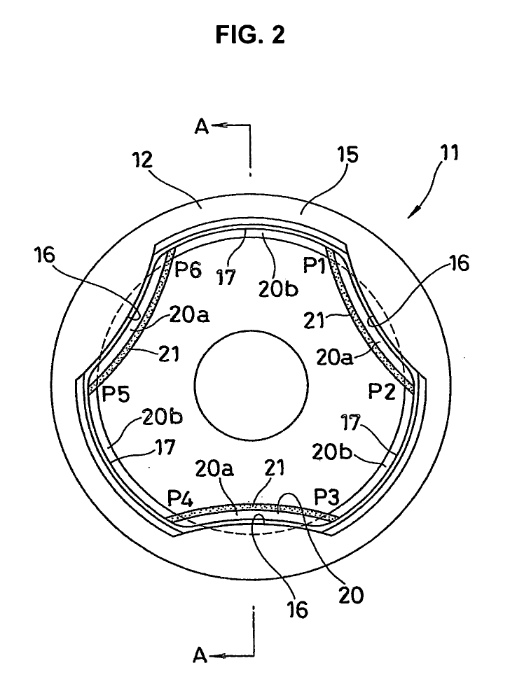

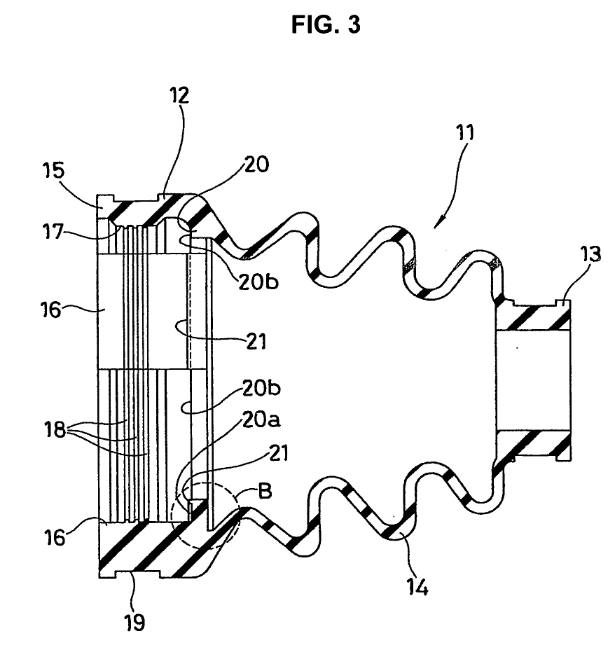

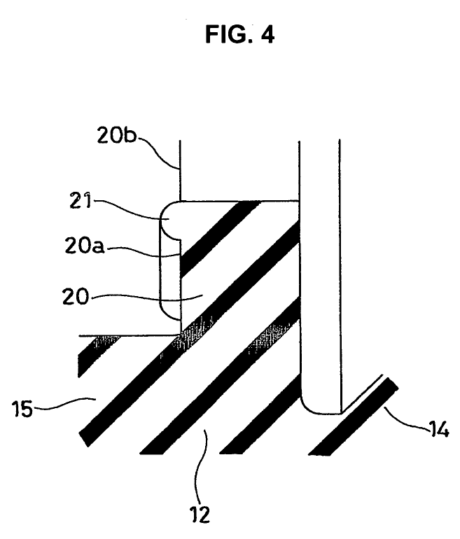

FIG. 1 shows a front view of an outer ring 2 of a joint 1 to which a boot 11 in accordance with a first embodiment of the present invention is attached. Further, FIG. 2 shows a front view of the boot 11, FIG. 3 shows a cross sectional view along a line A-A in FIG. 2, and FIG. 4 shows an enlarged view of a portion B in FIG. 3.

The joint 1 in FIG. 1 is a tri-port type constant velocity joint, and a curved recess portion 3 is provided at three circumferential positions on an outer peripheral surface of the outer ring 2 which is a constituting part of the tri-port type constant velocity joint. A leading end surface 4 of the outer ring 2 is formed in a flush planer shape all around an entire periphery, however, is divided into a recess portion leading end surface 4a corresponding to the circumferential recess portion 3, and the other leading end surface 4b, and both the elements 4a and 4b are alternately arranged at three circumferential positions, respectively.

The boot 11 in FIGS. 2 and 3 is a tri-port type boot attached to the tri-port type constant velocity joint 1 in FIG. 1, integrally has a large-diameter side mounting portion 12 mounted to the outer ring 2 of the joint 1, a small-diameter side mounting portion 13 mounted to an actuation shaft (not shown) of the joint 1, and a bellows portion 14 provided between both the mounting portions 12 and 13, as shown in FIG. 3, and is formed by a predetermined elastic plastic or a rubber or the like.

Among them, the large-diameter side mounting portion 12 is provided with a tubular portion 15 fitly attached to an outer peripheral side of the outer ring 2, and a curved convex portion 16 is provided at three circumferential positions on an inner peripheral surface of the tubular portion 15 in correspondence to the recess portion 3. Further, an inner peripheral surface of the tubular portion 15 is provided with an outer peripheral seal portion 17 having a seal bead 18 all around an entire periphery thereof, and an outer peripheral surface of the tubular portion 15 is provided with a band mounting groove 19 for mounting a metal band (not shown).

Further, an axial end surface portion 20 opposing to the leading end surface 4 of the outer ring 2 is provided all around an entire periphery of a bellows side end portion of the tubular portion 15. The axial end surface portion 20 is formed in a flush planer shape all around an entire periphery, however, is divided into an end surface portion 20a corresponding to the circumferential convex portion 16, and the other end surface portion 20b, and both the elements 20a and 20b are alternately arranged at three circumferential positions, respectively. The leading end surface 4a of the recess portion 3 of the outer ring 2 is opposed to the former convex portion corresponding end surface portion 20a.

In the structure mentioned above, when the large-diameter side mounting portion 12 of the boot 11 in FIGS. 2 and 3 is mounted to the outer peripheral side of the outer ring 2 in FIG. 1, the inner peripheral surface of the tubular portion 15 provided with the outer peripheral seal portion 17 is closely contacted with the outer peripheral surface of the outer ring 2, and in particular, the inner surface of the convex portion 16 is closely contacted with the outer surface of the recess portion 3 all around an entire surface. Accordingly, an improved sealing performance can be achieved, however, if a phase shift is generated between the outer ring 2 and the boot 11 due to some kind or another reason as mentioned above, a local circumferential gap is generated between the outer surface of the recess portion 3 and the inner surface of the convex portion 16, so that there is a risk that a lubricating grease (not shown) in an inner portion of the boot 11 leaks from the gap. Accordingly, the following seal structure is added to the boot 11 so as to prevent the grease from leaking even if the phase shift is generated between the outer ring 2 and the boot 11.

As shown in FIGS. 2 and 3, an end surface seal portion 21 is provided in each of the end surface portions 20a corresponding to the convex portions 16 in the axial end surface portions 20 of the large-diameter side mounting portion 12, and the end surface seal portion 21 is closely contacted with the leading end surface 4a of the recess portion 3 of the outer ring 2, where by a sealing performance is improved.

The end surface seal portion 21 is brought into close contact with the leading end surface 4a of the recess portion 3 of the outer ring 2 so as to rise a surface pressure, thereby achieving a seal effect with respect to the leading end surface 4a of the recess portion 3, and is formed in a lip shape or a bead shape as shown in FIG. 4 so as to elastically deform at a close contact time and generate a predetermined seal surface pressure on the basis of an elastic repulsion force. A rising direction of the lip or the bead is set to one direction in an axial direction from the end surface portion 20a.

Since the existence of the end surface seal portion 21 is hard to be understood in the front view of the boot 11 in FIG. 2, dots are added to the end surface seal portion 21. Then, a description will be again given of the structure of the boot 11 in accordance with FIG. 2.

The convex portion 16 is provided at three circumferential positions on the inner peripheral surface of the tubular portion 15 in the large-diameter side mounting portion 12 of the boot 11, and the axial end surface portion 20 is provided all around an entire periphery so as to thread out the inner peripheral surface of the tubular portion 15 and the inner surface of the convex portion 16. The axial end surface portion 20 is divided into the end surface portion 20a corresponding to the circumferential convex portion 16, and the other end surface portion 20b, and both the elements 20a and 20b are alternately arranged at three circumferential positions, respectively. In the drawing, the former convex portion corresponding end surface portion 20a is provided between points P1 and P2, between points P3 and P4 and between points P5 and P6 on the circumference, and the latter other end surface portion 20b is provided between points P2 and P3, between points P4 and P5 and between points P6 and P1.

Further, since the end surface seal portion 21 is provided in each of the former convex portion corresponding end surface portion 20a, and the end surface portion 20a corresponding to the convex portion 16 is provided at three circumferential positions, the end surface seal portion 21 is provided at three circumferential positions in correspondence thereto. Each of the end surface seal portions 21 is formed in an inward convex circular arc shape along the curve of the convex portion 16 as seen from a direction in FIG. 2, and both end portions in a longitudinal direction respectively reach an inner peripheral surface of the tubular portion 15 so as to be connected thereto. Further, each of the end surface seals 21 is brought into close contact with the leading end surface 4a of the recess portion 3 of the outer ring 2 so as to form a band shape as shown by a dotted line in FIG. 1.

Accordingly, even if the phase shift is generated between the outer ring 2 and the boot 11 due to some kind and another reason as mentioned above, so that the gap is generated between the outer surface of the recess portion 3 and the inner surface of the convex portion 16, the end surface seal portion 21 substantially closes the gap. Accordingly, it is possible to prevent the grease in the inner portion of the boot 11 from leaking to the external portion.

Further, in accordance with the boot 11, since a contact area with the outer ring 2 of the boot 11 is set large in comparison with the conventional boot provided with no end surface seal portion, a frictional force is increased, so that there can be obtained an effect of making the phase shift itself hard to be generated.

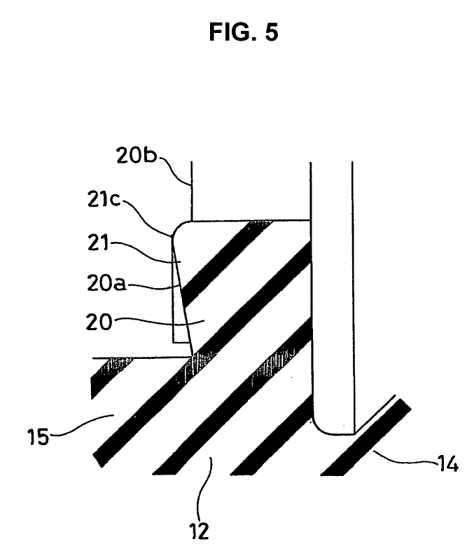

With respect to the shape of the end surface seal portion 21, the end surface seal portion 21 is formed in the lip shape or the bead shape having the semicircular cross section in FIG. 4, however, the shape is not particularly limited as far as the end surface seal portion can be brought into close contact with the leading end surface 4a of the recess portion 3 in the joint outer ring 2 so as to rise the seal surface pressure. For example, in FIG. 5, the structure is made such that the end surface portion 20a corresponding to the convex portion 16 is entirely formed in a taper surface shape or a conical surface shape, and an inner end protruding portion 20c is brought into close contact with the leading end surface 4a of the recess portion 3 of the outer ring 2.

### Second Embodiment (Relevance to Claim 2)

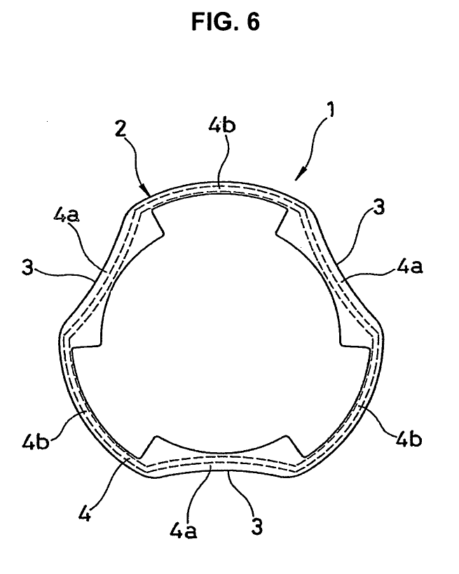

In the first embodiment mentioned above, the end surface seal portion 21 is provided in the respective positions (three circumferential positions) only in the end surface portion 20a corresponding to the convex portion 16 in the axial end surface portion 20 of the large-diameter side mounting portion 12, however, the end surface seal portion 21 may be provided all around the entire periphery of the axial end surface portion 20. FIGS. 6 to 8 show a case that the end surface seal portion 21 is provided all around the entire periphery of the axial end surface portion 20, in accordance with a second embodiment of the present invention.

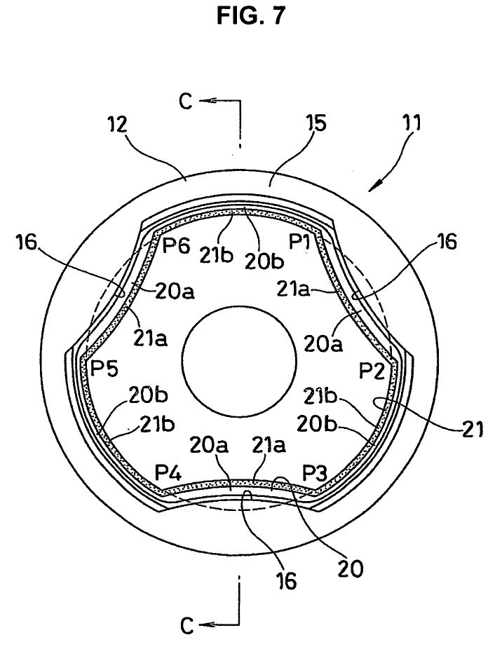

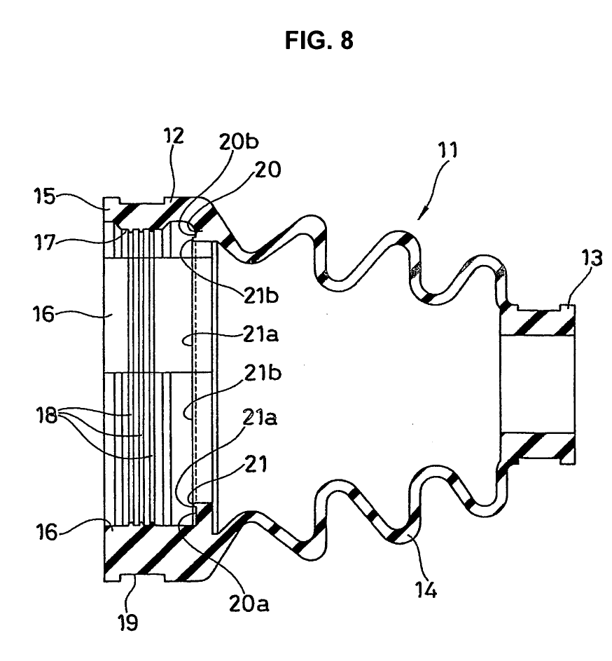

FIG. 6 shows a front view of an outer ring 2 of a joint 1 to which a boot 11 in accordance with a second embodiment of the present invention is attached. Further, FIG. 7 shows a front view of the boot 11, and FIG. 8 shows a cross sectional view along a line C-C in FIG. 7.

The joint 1 in FIG. 6 is a tri-port type constant velocity joint, and a curved recess portion 3 is provided at three circumferential positions on an outer peripheral surface of the outer ring 2 which is a constituting part of the tri-port type constant velocity joint. A leading end surface 4 of the outer ring 2 is formed in a flush planer shape all around an entire periphery, however, is divided into a recess portion leading end surface 4a corresponding to the circumferential recess portion 3, and the other leading end surface 4b, and both the elements 4a and 4b are alternately arranged at three circumferential positions, respectively.

The boot 11 in FIGS. 7 and 8 is a tri-port type boot attached to the tri-port type constant velocity joint 1 in FIG. 6, integrally has a large-diameter side mounting portion 12 mounted to the outer ring 2 of the joint 1, a small-diameter side mounting portion 13 mounted to an actuation shaft (not shown) of the joint 1, and a bellows portion 14 provided between both the mounting portions 12 and 13, as shown in FIG. 8, and is formed by a predetermined elastic plastic or a rubber or the like.

Among them, the large-diameter side mounting portion 12 is provided with a tubular portion 15 fitly attached to an outer peripheral side of the outer ring 2, and a curved convex portion 16 is provided at three circumferential positions on an inner peripheral surface of the tubular portion 15 in correspondence to the recess portion 3. Further, an inner peripheral surface of the tubular portion 15 is provided with an outer peripheral seal portion 17 having a seal bead 18 all around an entire periphery thereof, and an outer peripheral surface of the tubular portion 15 is provided with a band mounting groove 19 for mounting a metal band (not shown).

Further, an axial end surface portion 20 opposing to the leading end surface 4 of the outer ring 2 is provided all around an entire periphery of a bellows side end portion of the tubular portion 15. The axial end surface portion 20 is formed in a flush planer shape all around an entire periphery, however, is divided into an end surface portion 20a corresponding to the circumferential convex portion 16, and the other end surface portion 20b, and both the elements 20a and 20b are alternately arranged at three circumferential positions, respectively. The leading end surface 4a of the recess portion 3 of the outer ring 2 is opposed to the former convex portion corresponding end surface portion 20a.

In the structure mentioned above, when the large-diameter side mounting portion 12 of the boot 11 in FIGS. 7 and 8 is mounted to the outer peripheral side of the outer ring 2 in FIG. 6, the inner peripheral surface of the tubular portion 15 provided with the outer peripheral seal portion 17 is closely contacted with the outer peripheral surface of the outer ring 2, and in particular, the inner surface of the convex portion 16 is closely contacted with the outer surface of the recess portion 3 all around an entire surface. Accordingly, an improved sealing performance can be achieved, however, if a phase shift is generated between the outer ring 2 and the boot 11 due to some kind or another reason as mentioned above, a local circumferential gap is generated between the outer surface of the recess portion 3 and the inner surface of the convex portion 16, so that there is a risk that a lubricating grease (not shown) in an inner portion of the boot 11 leaks from the gap. Accordingly, the following seal structure is added to the boot 11 so as to prevent the grease from leaking even if the phase shift is generated between the outer ring 2 and the boot 11.

As shown in FIGS. 7 and 8, an end surface seal portion 21 is provided all around an entire periphery in the axial end surface portions 20 of the large-diameter side mounting portion 12, and the end surface seal portion 21 is closely contacted with the leading end surface 4a of the recess portion 3 of the outer ring 2, whereby a sealing performance is improved.

The end surface seal portion 21 is brought into close contact with the leading end surface 4 of the outer ring 2 all around the entire periphery so as to rise a surface pressure, thereby achieving a seal effect with respect to the leading end surface 4 of the outer ring 2, and is formed in a lip shape or a bead shape as shown in FIG. 4 for the first embodiment mentioned above so as to elastically deform at a close contact time and generate a predetermined seal surface pressure on the basis of an elastic repulsion force. A rising direction of the lip or the bead is set to one direction in an axial direction from the end surface portion 20. In this case, as mentioned in the first embodiment, the shape of the end surface seal portion 21 is not limited.

Since the existence of the end surface seal portion 21 is hard to be understood in the front view of the boot 11 in FIG. 7, dots are added to the end surface seal portion 21. Then, a description will be again given of the structure of the boot 11 in accordance with FIG. 7.

The convex portion 16 is provided at three circumferential positions on the inner peripheral surface of the tubular portion 15 in the large-diameter side mounting portion 12 of the boot 11, and the axial end surface portion 20 is provided all around an entire periphery so as to thread out the inner peripheral surface of the tubular portion 15 and the inner surface of the convex portion 16. The axial end surface portion 20 is divided into the end surface portion 20a corresponding to the circumferential convex portion 16, and the other end surface portion 20b, and both the elements 20a and 20b are alternately arranged at three circumferential positions, respectively. In the drawing, the former convex portion corresponding end surface portion 20a is provided between points P1 and P2, between points P3 and P4 and between points P5 and P6 on the circumference, and the latter other end surface portion 20b is provided between points P2 and P3, between points P4 and P5 and between points P6 and P1.

Further, the end surface seal portion 21 is provided all around the entire periphery of the axial end surface portion 20, and the end surface portion 20 is divided into the end surface seal portion 21a corresponding to the convex portion 16 provided in the end surface portion 20a corresponding to the convex portion 16, and the other end seal portion 21b provided in the other end surface portion 20b, and both the seal portions 21a and 21b are alternately arranged at three circumferential positions, respectively. In the drawing, the former convex portion corresponding end surface seal portion 21a is provided between the points P1 and P2, between the points P3 and P4 and between the points P5 and P6 on the circumference, and the latter other end surface seal portion 21b is provided between the points P2 and P3, between the points P4 and P5 and between the points P6 and P1 on the circumference. Further, the end surface seal 21 is brought into close contact with the leading end surface 4 of the outer ring 2 so as to form a band shape and an endless shape as shown by a dotted line in FIG. 6.

Accordingly, even if the phase shift is generated between the outer ring 2 and the boot 11 due to some kind and another reason as mentioned above, so that the gap is generated between the outer surface of the recess portion 3 and the inner surface of the convex portion 16, the end surface seal portion 21 substantially closes the gap. Accordingly, it is possible to prevent the grease in the inner portion of the boot 11 from leaking to the external portion.

Further, in accordance with the boot 11, since a contact area with the outer ring 2 of the boot 11 is set large in comparison with the conventional boot provided with no end surface seal portion, a frictional force is increased, so that there can be obtained an effect of making the phase shift itself hard to be generated.

### EFFECT OF THE INVENTION AND INDUSTRIAL APPLICABILITY

The present invention achieves the following effects.

In the boot in accordance with the first aspect of the present invention provided with the structure mentioned above, since the end surface seal portion is provided at the position opposing to the leading end surface of the joint recess portion in the axial end surface portion of the large-diameter side mounting portion of the boot, and the end surface seal portion is brought into close contact with the leading end surface of the recess portion, thereby generating the seal surface pressure so as to achieve the seal effect, it is possible to close the gap between the boot and the joint even if the phase shift is generated between both the elements, and it is possible to secure the sealing performance between both the elements. Accordingly, it is possible to effectively prevent the grease from leaking from the portion between the boot and the joint. Further, since the contact area with the joint is increased in accordance with the addition of the end surface seal portion so that the frictional force is increased, it is possible to control the phase shift generated between the boot and the joint small.

Further, in the boot in accordance with the second aspect of the present invention provided with the structure mentioned above, since the end surface seal portion is provided all around the periphery in the axial end surface portion of the large-diameter side mounting portion of the boot, and the end surface seal portion is brought into close contact with the leading end surface of the joint outer ring, thereby generating the seal surface pressure so as to achieve the seal effect, it is possible to close the gap between the boot and the joint even if the phase shift is generated between both the elements, and it is possible to secure the sealing performance between both the elements. Accordingly, it is possible to effectively prevent the grease from leaking from the portion between the boot and the joint. Further, since the contact area with the joint is increased in accordance with the addition of the end surface seal portion so that the frictional force is increased, it is possible to control the phase shift generated between the boot and the joint small.

1. A boot (11) for a constant velocity joint having a large-diameter side mounting portion (12) mounted to an outer ring (2) of a constant velocity joint (1) provided with a plurality of circumferential recess portions (3) on an outer peripheral surface, in which a tubular portion (15) fitly attached to an outer peripheral side of said outer ring (2), a plurality of circumferential convex portions (16) provided on an inner peripheral surface of said tubular portion (15) in correspondence to said recess portion (3), and an axial end surface portion (20) opposing to a leading end surface (4) of said outer ring (2) are integrally formed in said large-diameter side mounting portion (12),
wherein an end surface seal portion (21) is provided at a position opposing to a leading end surface (4a) of said recess portion (3) in the axial end surface portion (20) of said large-diameter side mounting portion (12), and said end surface seal portion (21) is brought into close contact with the leading end surface (4a) of said recess portion (3), thereby generating a seal surface pressure to achieve a seal effect.

2. A boot (11) for a constant velocity joint having a large-diameter side mounting portion (12) mounted to an outer ring (2) of a constant velocity joint (1) provided with a plurality of circumferential recess portions (3) on an outer peripheral surface, in which a tubular portion (15) fitly attached to an outer peripheral side of said outer ring (2), a plurality of circumferential convex portions (16) provided on an inner peripheral surface of said tubular portion (15) in correspondence to said recess portion (3), and an axial end surface portion (20) opposing to a leading end surface (4) of said outer ring (2) are integrally formed in said large-diameter side mounting portion (12),
wherein an end surface seal portion (21) is provided all around an entire periphery of the axial end surface portion (20) of said large-diameter side mounting portion (12), and said end surface seal portion (21) is brought into close contact with the leading end surface (4) of said outer ring (2), thereby generating a seal surface pressure to achieve a seal effect.
